(19) United States
(12) Patent Application Publication
(10) Pub. No.: US 2010/0302251 A1
(43) Pub. Date: Dec. 2, 2010

(54) STRUCTURE OF ANIMATION FONT FILE AND TEXT DISPLAYING METHOD OF HANDHELD TERMINAL

(75) Inventors: JEONG-HWAN YOON, Seoul (KR); Yong-Rak Park, Gyeonggi-do (KR); Jae-Wook Kim, Seoul (KR); Weon-Jun Kim, Gyeonggi-do (KR)

Correspondence Address: David A. Einhorn, Esq.;Baker & Hostetler LLP, 45 Rockefeller Plaza, New York, NY, 10111, US

(73) Assignee: RIXCO CO., LTD., SEOUL (KR)

(21) Appl. No.: 12/788,939

(22) Filed: May 27, 2010

(30) Foreign Application Priority Data
Jun. 2, 2009 (KR) 10-2009-0048608

(51) Int. Cl. G06T 11/00; G06F 17/00

(52) U.S. Cl. 345/467; 715/269

(57) ABSTRACT

The present disclosure relates to a structure of an animation font file and a text displaying method of a handheld terminal. The structure of the animation font file and the text displaying method may realize an animation using limited hardware resources without using images or videos by sequentially displaying plural font images with respect to input text data in accordance with times set for each frame, in which the text data are input by storing font images through a basic mapping table and an extended mapping table, so as to output different font images for each frame with respect to one text data.

### BACKGROUND OF THE INVENTION

1. Field of the Invention

The present invention relates to a structure of an animation font file and a text displaying method of a handheld terminal and, more particularly, to a structure of an animation font file and a text displaying method of a handheld terminal that may realize an animation by sequentially displaying plural font images with respect to input text data in accordance with times set for each frame, in which the text data are input by storing font images through a basic mapping table and an extended mapping table, so as to output different font images for each frame with respect to one text data.

2. Description of the Related Art

In the case where a user inputs a phone number to make a phone call or inputs characters to make a memo or a short sentence message in a handheld terminal such as a cellular phone or PDA (Personal Digital Assistant), the user can feel a more vivid visual sense, if various animation effects are generated for the message input by the user.

However, in order to realize such effects, it is necessary to have a new technical scheme, which is effective between an OS (Operating System) of the cellular phone (or PDA) and an animation engine, animation content, and a display unit, other than an existing simple scheme which displays font images corresponding to the characters input by the user on a screen. Furthermore, it is difficult to effectively support such a new technical scheme using limited hardware resources.

It should be understood that the aforementioned techniques refer to the related arts to which the invention pertains, and are not conventional techniques.

### SUMMARY OF THE INVENTION

The present invention is directed to solving the aforementioned problems, and an aspect of the present invention is to provide a structure of an animation font file and a text displaying method of a handheld terminal that may realize an animation by sequentially displaying plural font images with respect to input text data in accordance with times set for each frame, in which the text data are input by storing font images through a basic mapping table and an extended mapping table, so as to output different font images for each frame with respect to one text data.

According to an aspect of the invention, a structure of an animation font file includes a font header region that indicates a font header including basic information of a font; a font information region that indicates basic font information for displaying text data and animation font information for animating the text data; a basic mapping table region that indicates a basic mapping table for mapping the text data and font images in accordance with the basic font information; an extended mapping table region that indicates a plurality of extended mapping tables for mapping the text data and font images in accordance with the animation font information; and a data region that stores data of the font images.

The animation font information may include the number of frames for realizing an animation, the number of extended mapping tables, mapping information between the respective frames and the extended mapping tables, and time information indicating a time for which one frame is maintained on a screen.

The data region may include a bitmap data region for storing font images using a bitmap scheme and a vector data region for storing font images using a vector scheme.

According to another aspect of the invention, a text displaying method of a handheld terminal includes loading a font file to be used to display text data when the text data are input in a handheld terminal; determining whether animation font information is included in the font file; and displaying font images by reading the font images in accordance with the animation font information if the animation font information is included in the font file, and displaying font images by reading the font images in accordance with basic font information if the animation font information is not included in the font file.

A structure of the font file may includes a font header region that indicates a font header including basic information of a font, a font information region that indicates basic font information for displaying the text data and animation font information for animating the text data, a basic mapping table region that indicates a basic mapping table for mapping the text data and font images in accordance with the basic font information, an extended mapping table region that indicates a plurality of extended mapping tables for mapping the text data and font images in accordance with the animation font information, and a data region that stores data of the font images.

The animation font information may include the number of frames for realizing an animation, the number of extended mapping tables, mapping information between the respective frames and the extended mapping tables, and time information indicating a time for which one frame is maintained on a screen.

The data region may include a bitmap data region for storing font images using a bitmap scheme and a vector data region for storing font images using a vector scheme.

The step of loading a font file may include: reading the basic mapping table in accordance with the basic font information by reading the font information region; reading the extended mapping tables in accordance with the animation font information, if the animation font information is included in the font information region; and reading the font images in accordance with the basic mapping table and the extended mapping tables.

The step of displaying font images by reading the font images may include reading a plurality of the font images in accordance with the animation font information through the extended mapping tables and displaying the font images mapped for each frame in accordance with time information indicating a time for which one frame is maintained on a screen.

### BRIEF DESCRIPTION OF THE DRAWING

The above and other aspects, features and advantages of the present invention will become apparent from the following detailed description in conjunction with the accompanying drawings, in which:

FIG. 1 is a diagram of a structure of an animation font file in accordance with one embodiment of the present invention;

FIG. 2 illustrates font images for each frame stored in an animation font file in accordance with one embodiment of the present invention;

FIG. 3 is a flowchart of a text displaying method of a handheld terminal in accordance with one embodiment of the present invention; and

FIG. 4 is a flowchart of a process for loading a font file in the method in accordance with the embodiment of the present invention.

### DETAILED DESCRIPTION OF THE EMBODIMENTS

Embodiments of the invention will now be described in detail with reference to the accompanying drawings. It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosure set forth herein.

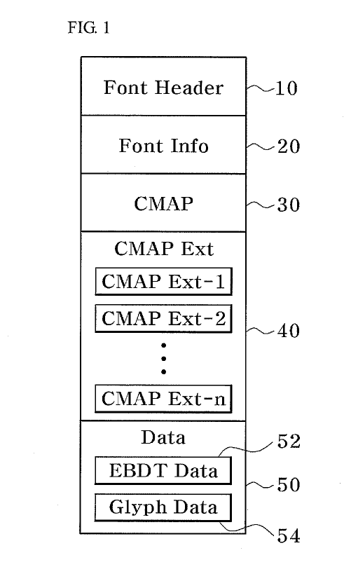

FIG. 1 is a diagram of a structure of an animation font file in accordance with one embodiment of the present invention.

Referring to FIG. 1, the structure of the animation font file according to one embodiment includes a font header region (Font Header) 10 that indicates a font header including basic information of a font; a font information region (Fontinfo) 20 that indicates basic font information for displaying text data and animation font information for animating the text data; a basic mapping table region (CMAP) 30 that indicates a basic mapping table for mapping the text data and font images in accordance with the basic font information; an extended mapping table region (CMAP Ext) 40 that indicates a plurality of extended mapping tables (CMAP Ext-1, CMAP Ext-2, . . . , CMAP Ext-n) for mapping the text data and font images in accordance with the animation font information; and a data region (Data) 50 that stores data of the font images.

The data region 50 includes a bitmap data region (EBDT Data) 52 for storing font images using a bitmap scheme, and a vector data region (Glyph Data) 54 for storing font images using a vector scheme.

The font header region 10 includes version information of a font, permissions, and a typeface name.

The font information region 20 includes, as the basic font information, the number of font images stored in the data the region 50, supporting language system, coordinate system information of text data, style information of lines, and, as the animation font information, the number of frames for realizing an animation, the number of extended mapping tables, mapping information between the respective frames and the extended mapping tables, and time information indicating a time for which one frame is maintained on a screen.

In the extended mapping table region (CMAP Ext), the text data and the font images are mapped for each frame, and the number of extended mapping tables is less than or equal to the number of frames.

That is, in the case where one mapping table is mapped from many frames upon mapping the extended mapping tables for each frame in the animation font information, the number of extended tables may be less than the number of frames.

Alternatively, the text data and new fonts (sub-fonts) may be mapped to the extended mapping table for each frame to allow the sub-fonts to be displayed in an application program.

In this manner, an animation may be realized by dividing a series of processes, in which one text data is changed, into the respective frames to display one text data, storing the text data as plural font images in the data region, and mapping the text data and visually expressed font image suitable for respective frame steps through the extended mapping table.

The above configuration will be described in conjunction with a specific example as follows.

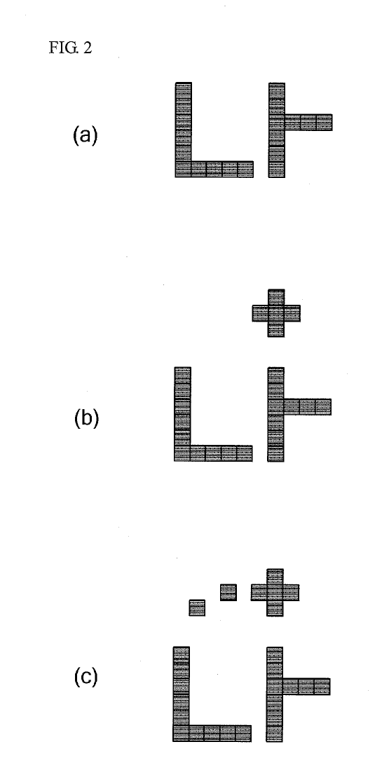

FIG. 2 illustrates font images for each frame stored in an animation font file according to one embodiment of the invention.

Referring to FIG. 2, in order to display text data “ [symbol] ” which is an animation font, the text data is divided into three frames, and font images (a), (b) and (c) corresponding to the respective frames are mapped through a basic mapping table region (CMAP), a first extended mapping table (CMAP Ext-1) and a second extended mapping table (CMAP Ext-2) of the extended mapping table region (CMAP Ext) to be stored in a data region 50, respectively.

Then, the text data and the basic mapping table are mapped in accordance the basic font information, and the first extended mapping table (CMAP Ext-1) and the second extended mapping table (CMAP Ext-2) are mapped for the respective frames so as to allow the font images (b) and (c) to be displayed in accordance with the animation font information.

Therefore, in the case where the text data “ [symbol] ” are input, when a period of time, for which one frame is maintained on a screen in accordance with the animation information, elapses after the font image (a) is displayed by the basic mapping table, the font images (b) and (c) are sequentially output by the extended mapping tables, so that the three font images shown in FIG. 2 for the text data “ [symbol] ” are sequentially repeated, thereby realizing an animation.

Further, it is possible to realize the same animation in reverse by reversely mapping the mapping information between the frames and the mapping tables in the animation font information.

For a system that cannot handle the animation font information, it is possible to display only the font image (a) which is mapped by the basic mapping table with respect to the text data “ [symbol] ” input by reading the basic font information in the font information region of the animation font file.

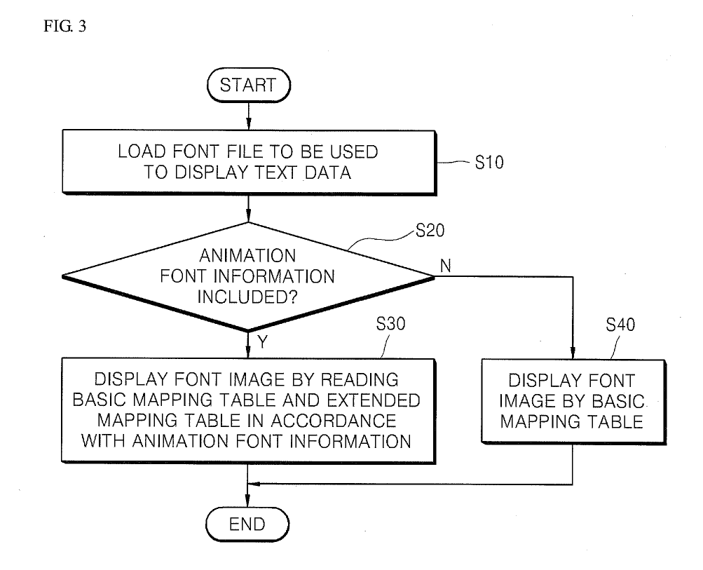

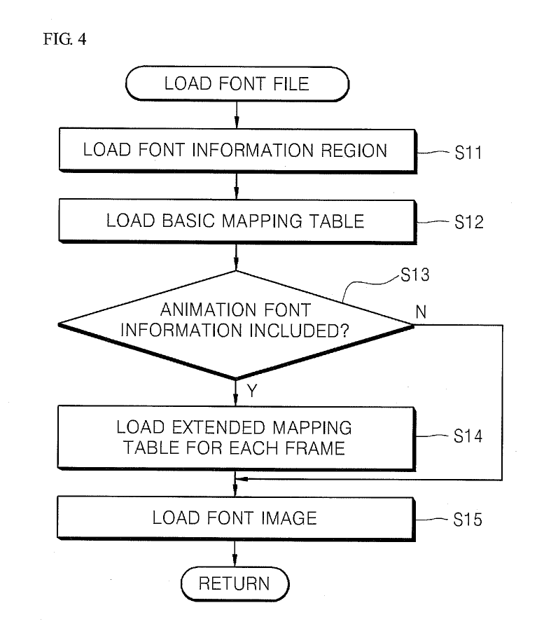

FIG. 3 is a flowchart of a text displaying method of a handheld terminal according to one embodiment of the invention, and FIG. 4 is a flowchart of a process for loading a font file in the method according to the embodiment of the invention.

In this embodiment, an engine capable of handling animation font information is installed and executed in a handheld terminal, and a font file will be described with reference to an example wherein the font file having the structure of the animation font file as shown in FIG. 1 is stored.

Referring to FIG. 3, first, a font file to be used to display text data is loaded when the text data are input through a key in the handheld terminal (not shown). Here, an animation font file is loaded as the font file to be used to display the text data when an animation font is selected as a font to display the text data in S10.

When loading the animation font file, a font information region 20 is loaded with respect to the font file selected through a font header, as shown in FIG. 4, in S11.

Then, a basic mapping table is loaded in accordance with the basic font information in S12.

Next, it is determined in S13 whether animation font information is included in the font information region 20, and, if the animation font information is included in the font information region, an extended mapping table for each frame is loaded in accordance with the animation font information in S14.

Font images are loaded through the basic mapping table and the extended mapping table in accordance with the basic font information and the animation font information in S15.

After the font file used to display the text data is loaded as above, it is determined whether the animation font information is included in font information in S20. Here, if the animation font information is included in the font information, when a period of time, for which one frame is maintained in accordance with animation information, elapses after a font image (a) is displayed by the basic mapping table with respect to text data “ [symbol] ”, as shown in FIG. 2, font images (b) and (c) are sequentially output by the extended mapping tables, so that the three font images for the text data “ [symbol] ” are sequentially repeated, thereby realizing an animation.

If a sub-font is mapped to the extended mapping table, font images of the sub-font are sequentially displayed for each frame in an application program, thereby realizing an animation.

However, in the case where the animation font information is not included in the font information, the font images are displayed by reading the font image (a) in accordance with the basic font information with respect to the input text data.

As apparent from the above description, according to the embodiments, the structure of the animation font file and the text displaying method may realize an animation using limited hardware resources without using images or videos by sequentially displaying plural font images with respect to input text data in accordance with times set for each frame, in which the text data are input by storing font images through a basic mapping table and an extended mapping table, so as to output different font images for each frame with respect to one text data.

Further, according to the embodiments, the structure of the animation font file and the text displaying method may allow a system, which cannot handle the animation font information, to display text data input through basic font information.

Although the embodiments have been provided to illustrate the invention in conjunction with the drawings, it will be apparent to those skilled in the art that the embodiment are given by way of illustration only, and that various modifications, changes, alterations, and equivalent embodiments can be made without departing from the spirit and scope of the invention. The scope of the invention should be limited only by the accompanying claims.

What is claimed is:

1. A structure of an animation font file, comprising:
a font header region that indicates a font header including basic information of a font;
a font information region that indicates basic font information for displaying text data and animation font information for animating the text data;
a basic mapping table region that indicates a basic mapping table for mapping the text data and font images in accordance with the basic font information;
an extended mapping table region that indicates a plurality of extended mapping tables for mapping the text data and font images in accordance with the animation font information; and
a data region that stores data of the font images.

2. The structure according to claim 1, wherein the animation font information comprises the number of frames for realizing an animation, the number of extended mapping tables, mapping information between the respective frames and the extended mapping tables, and time information indicating a time for which one frame is maintained on a screen.

3. The structure according to claim 1, wherein the data region comprises a bitmap data region for storing font images using a bitmap scheme and a vector data region for storing font images using a vector scheme.

4. A text displaying method of a handheld terminal, comprising:
loading a font file to be used to display text data when the text data are input in a handheld terminal;
determining whether animation font information is included in the font file; and
displaying font images by reading the font images in accordance with the animation font information if the animation font information is included in the font file, and displaying font images by reading the font images in accordance with basic font information if the animation font information is not included in the font file.

5. The text displaying method according to claim 4, wherein a structure of the font file includes:
a font header region that indicates a font header including basic information of a font;
a font information region that indicates basic font information for displaying the text data and animation font information for animating the text data;
a basic mapping table region that indicates a basic mapping table for mapping the text data and font images in accordance with the basic font information;
an extended mapping table region that indicates a plurality of extended mapping tables for mapping the text data and font images in accordance with the animation font information; and
a data region that stores data of the font images.

6. The text displaying method according to claim 5, wherein the animation font information comprises the number of frames for realizing an animation, the number of extended mapping table, mapping information between the respective frames and the extended mapping tables, and time information indicating a time for which one frame is maintained on a screen.

7. The text displaying method according to claim 5, wherein the data region comprises a bitmap data region for storing font images using a bitmap scheme and a vector data region for storing font images using a vector scheme.

8. The text displaying method according to claim 5, wherein the step of loading a font file comprises:
reading the basic mapping table in accordance with the basic font information by reading the font information region;
reading the extended mapping tables in accordance with the animation font information, if the animation font information is included in the font information region; and
reading the font images in accordance with the basic mapping table and the extended mapping tables.

9. The text displaying method according to claim 5, wherein the step of displaying font images by reading the font images comprises reading a plurality of the font images in accordance with the animation font information through the extended mapping tables and displaying the font images mapped for each frame in accordance with time information indicating a time for which one frame is maintained on a screen.
